(19) United States
(12) Patent Application Publication
(10) Pub. No.: US 2003/0232554 A1
(43) Pub. Date: Dec. 18, 2003

(54) Multi-layer tacky and water-absorbing shoe-cleaning product

(76) Inventors: Ronald D. Blum, Roanoke, VA (US); William Kokonaski, Gig Harbor, WA (US); Andrew Gentiluomo, Roanoke, VA (US); Joseph A. Thibodeau, Roanoke, VA (US); Bradley J. Blum, Roanoke, VA (US); Dwight P. Duston, Laguna Niguel, CA (US); Peter W. Kopf, Sudbury, MA (US)

Correspondence Address: William E. Curry, KENYON & KENYON, Suite #700, 1500 K Street, N.W., Washington, DC, 20005, US

(21) Appl. No.: 10/395,793

(22) Filed: Mar. 25, 2003

Related U.S. Application Data
(63) Continuation-in-part of application No. 09/985,456, filed on Nov. 2, 2001.
(63) Continuation-in-part of application No. 09/553,234, filed on Apr. 19, 2000, now Pat. No. 6,233,776.
(63) Continuation-in-part of application No. 09/418,752, filed on Oct. 15, 1999, now abandoned.
(63) Continuation-in-part of application No. 09/304,051, filed on May 4, 1999, now Pat. No. 6,219,876.
(60) Provisional application No. 60/366,541, filed on Mar. 25, 2002.

(51) Int. Cl. B32B 27/04; B32B 5/18; B32B 27/12; B32B 5/22

(52) U.S. Cl. 442/76; 442/86

(57) ABSTRACT

Embodiments of the present invention relate to shoe-cleaning product comprising a first or top water-absorbing layer having a tacky top exposed surface. The water-absorbing layer is adjacent to a water-resistant layer. An apparatus for dispensing the shoe-cleaning material, and an apparatus comprising the shoe-cleaning material in combination with a floor covering, are also disclosed.

This application claims the benefit under 35 USC section 119(e) of U.S. provisional application No. 60/366,541, filed Mar. 25, 2002. Further, this application is a continuation-in-part of U.S. application serial no. 985,456, filed Nov. 2, 2001. Further, this application is a continuation-in-part of U.S. application Ser. No. 09/553,234, filed Apr. 19, 2000 and issued May 22, 2001 as U.S. Pat. No. 6,233,776. application Ser. No. 09/553,234 is a continuation-in-part of U.S. application Ser. No. 09/418,752, filed Oct. 15, 1999, which is a continuation-in-part of U.S. application Ser. No. 09/304,051, filed May 4, 1999 and issued Apr. 24, 2001 as U.S. Pat. No. 6,219,876.

### FIELD OF THE INVENTION

The present invention relates to a product for cleaning shoes. More specifically, it relates to a product comprising a first or upper layer of material that is both water-absorbing and tacky, and a second or lower layer adjacent to the upper layer that is water-resistant.

### BACKGROUND

Tacky materials used for cleaning shoes are known. For example, as described in U.S. Pat. No. 6,219,876 B1, which is fully incorporated herein by reference, tacky surfaces are used in floor mats near an entryway to a home, business, or commercial establishment. Although they are primarily designed for use near an entryway which leads directly to the outside weather elements existing tacky surfaces currently lack the capability for absorbing or transmitting water to any appreciable degree. In order to increase the overall effectiveness of such tacky surfaces, when exposed to the wet sole of a shoe, there is a need for shoe-cleaning materials utilizing a tacky surface that will allow for water absorption. Moreover, it would be advantageous to provide such a tacky surface material with a water-resistant surface on the other side from the tacky, water-absorbing surface, in order to shield objects from moisture in the water-absorbing portion.

### BRIEF DESCRIPTION OF THE DRAWINGS

FIG. 1A shows a two-layer shoe-cleaning product according to an embodiment of the invention;

FIG. 1B shows the product arranged as sheets in a stack;

FIG. 2 shows an embodiment of the shoe-cleaning product with openings to engage an anti-slip component;

FIGS. 3A and 3B illustrate the shoe-cleaning product in combination with a base portion having anti-slip components;

FIG. 4 illustrates an embodiment where anti-slip components are formed on a top exposed surface of the shoe-cleaning product;

FIG. 5 shows the embodiment of FIG. 4 in combination with a base portion;

FIG. 6 shows a dispensing apparatus for use with the shoe-cleaning product;

FIGS. 7A and 7B show the shoe-cleaning product in combination with a floor covering; and

FIG. 8 shows an alternative embodiment of the shoe-cleaning product in combination with a floor covering.

### DETAILED DESCRIPTION

In consideration of the above, embodiments of the present invention relate to a shoe-cleaning product comprising a first layer that includes a water-absorbing material and having a porous top tacky exposed surface, and a second layer comprising water-resistant material, adjacent to the first layer. The tackiness of the porous top surface enhances its ability to remove dirt while its porosity enables transmitting water into the bulk of the water-absorbing material just below the surface. Moreover, the water-absorbing capability extends the usefulness the product to applications that are near an outdoor area, such as just inside an entry where wet shoes are more likely to be encountered. The second, water-resistant layer protects objects and surfaces which may be under the water-absorbing layer, as discussed in more detail below.

To facilitate its use in shoe-cleaning applications, in embodiments the product could be used in association with a dispensing apparatus capable of being stepped and walked on. As described in more detail below, such an apparatus could comprise at least a housing configured to receive the shoe-cleaning product, and one or more mechanisms for securing and/or dispensing the product.

The shoe-cleaning product could be used independently, for example in the form of a stack of sheets placed on a backing or base on a floor, or could be used in combination with more traditional floor coverings. For example, the shoe-cleaning product could form part of the top exposed surface of a floor covering that also included surfaces such as carpeting, sisal, fabric, rubber, plastic or the like.

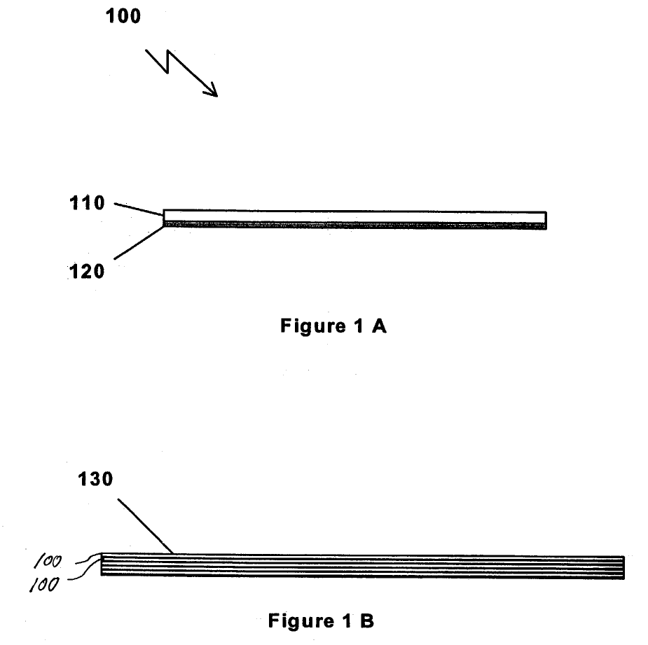

FIG. 1A illustrates an embodiment of the present invention. FIG. 1A is a side orthogonal view of a shoe-cleaning product 100 comprising a first or top layer 110 of water-absorbing material. The top layer 110 may have a porous top tacky exposed surface. Such a porous, tacky surface could be formed, for example, by applying an adhesive to a water-absorbing material having a substantially coarse texture or weave, so that applying the adhesive did not clog or block small openings or pores distributed through the material. Alternatively, a non-porous tacky surface could first be applied to the water-absorbing layer and pores could be formed in the tacky surface thereafter. The water-absorbing layer 110 could be formed from, for example, woven or non-woven fabrics comprising natural or man-made fibers, paper towels, sponge or cloth. To aid in cleaning, the water-absorbing layer may be impregnated with a cleaning solution such as dry water-soluble mild detergents. The cleaning solution, and adhesives for making the top exposed surface tacky, may include anti-bacterial agents for better sanitation. If the water-absorbing layer is impregnated with a cleaning solution, the solution may include additives to help prevent the solution from evaporating. Water-binding materials for slowing evaporation are well known and include, for example, hydrolyzed cellulose, hydrolyzed polyacrylonitrite, and PVA (polyvinylalcohol). The first layer could also be treated to give it electrostatic properties when dry, to cause it to attract dirt when dry.

Adjacent to the first or water-absorbing layer 110 is a second or lower layer 120 that is water-resistant (i.e., does not transfer water). The water-resistant layer 120 could be formed as, for example, a thin film comprising plastics, including polymers such as polyester, polyethylene, or polypropylene. Additionally or alternatively, the thin film could comprise rubber or rubber-like materials such as silicone rubber, polyurethane, or latex. Such a water-resistant layer may also be sprayed or otherwise coated onto the water-absorbing layer and then cured in-situ. Any other waterblocking/water-resistant materials could also be used for the water-resistant layer. The water-resistant layer could be bonded to the water-absorbing layer, for example with an adhesive or glue, thermally bonded, or bonded by way of light curable resins. The water-absorbing layer could be laminated to the water-resistant layer when the water-resistant layer is being extruded or formed. Other materials which could be used in forming the shoe-cleaning product include materials as described in U.S. Pat. No. 6,298,517, which is fully incorporated herein by reference.

The first and second layers may be formed into a composite unitary member, e.g., by bonding together as described above and cutting to a predetermined size and shape. They can also be formed in-situ. FIG. 1B shows an embodiment of the shoe-cleaning product 100 where the product has been formed into a plurality of composite unitary members or sheets and arranged as a stack 130. The sheets may be separable SO that they can be used in a serial fashion. More specifically, the stack may be placed on a floor, and a top sheet thereof may be used for cleaning shoes until it is soiled. The top sheet may then be removed and disposed of, to expose a clean sheet below for use until it, in turn, is disposed of. An advantage of the water-resistant layer 120 in this configuration is that it acts as a barrier to prevent water from a top exposed water-absorbing layer from passing through to contaminate or soil sheets below. Also, it may make sheets in a stack easier to separate. Further, if the water-absorbing layer is impregnated with a cleaning solution, it may help to slow or prevent evaporation of the cleaning solution.

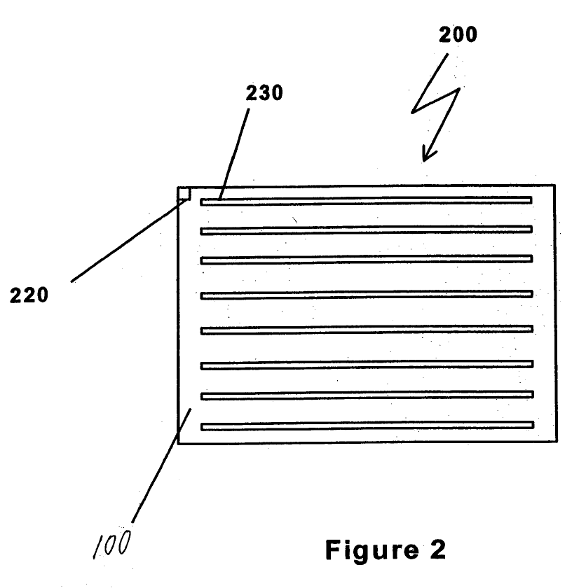

FIG. 2 shows a view from above of an embodiment 200 wherein a sheet of shoe-cleaning product 100 may have openings 230 formed therein to receive an anti-slip component of a base portion that may be used in combination with the shoe-cleaning product. A sheet may have a tab 220 to facilitate manipulation of the sheet, in particular, for example, to make it easier remove from a stack. The sheet of cleaning product could be large enough to accommodate a pair of adult shoes thereon.

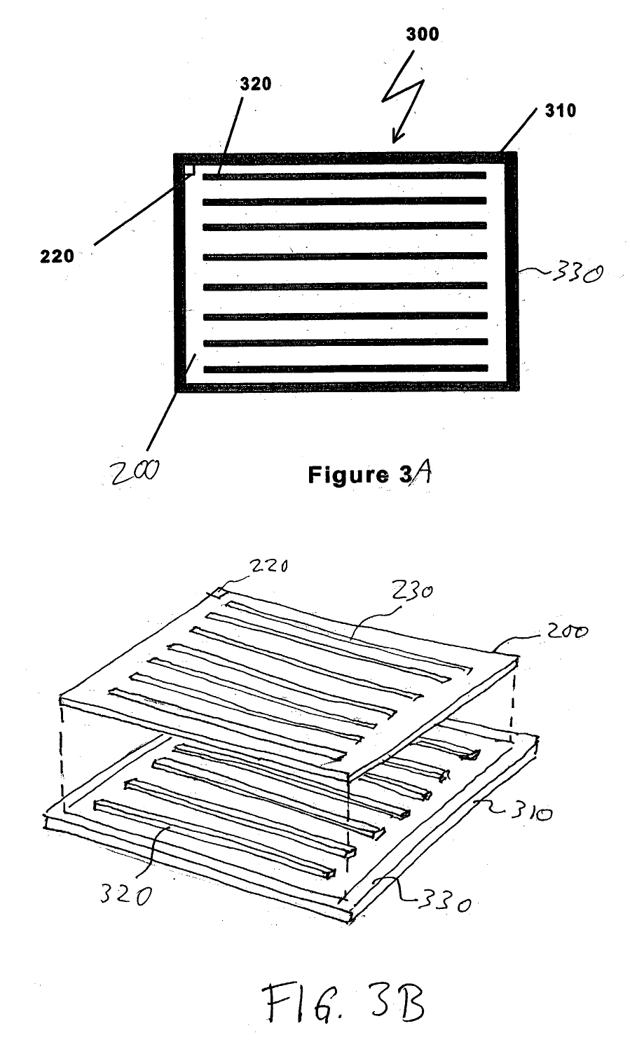

FIG. 3A shows a view from above of an embodiment 300 wherein the embodiment of FIG. 2 is associated with a base portion 310. The base portion 310 comprises anti-slip components 320, which may be formed as elongated treads, to help prevent a person from slipping on the shoe-cleaning product 200 when it or the person's shoes are wet. An anti-slip component may take other forms, as described later. FIG. 3B is a perspective view illustrating how a sheet of shoe-cleaning product 200 with openings 320 may be removably associated with the base portion 310. The base portion may have a border 330 that extends beyond a surface area of the shoe-cleaning product 200, and the shoe-cleaning product may be removably received within the border. The border 330 could be raised to help secure the shoe-cleaning product, but need not be. The openings 230 are adapted to engage corresponding anti-slip components 320 of the base portion, which would also help to secure the shoe-cleaning product to the base portion and prevent it from deforming, e.g., bunching at one end, when it is used. A bottom surface of the shoe-cleaning product could have adhesive thereon to help secure it to the base portion. Sheets of the shoe-cleaning product 200 could be arranged in a stack and placed in or on the base portion.

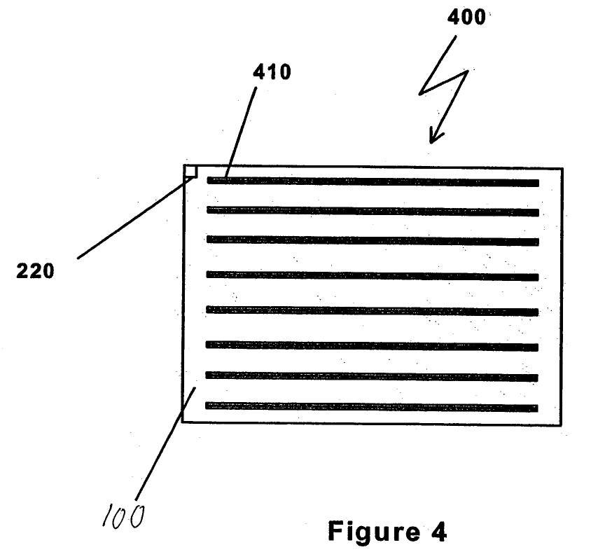

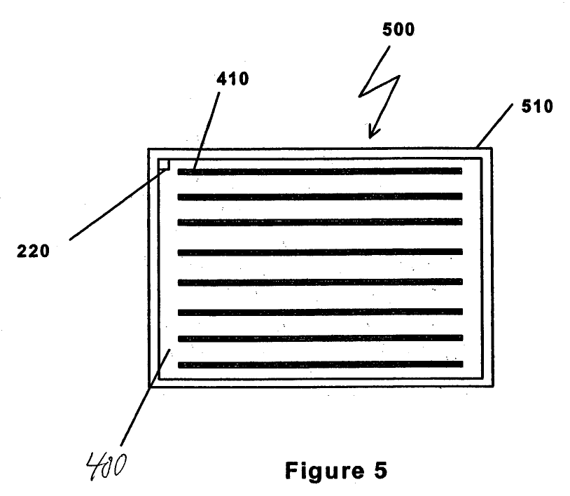

FIG. 4 shows an alternative embodiment 400 wherein a sheet of shoe-cleaning product 100 has anti-slip components 410 on its top exposed surface, as opposed to openings for engaging anti-slip components of a base portion. In such an embodiment, strips of an anti-slip material 410 such as, by way of example only, treads, thin strips of rubber, or thin adhesive strips containing grit or abrasives such as fine sand, silica or other high friction materials, could be bonded directly to the top exposed surface. When utilizing a tread as an anti-slip component, the tread can be round, oval, square, rectangular, diamond, or virtually any other shape. The sheet of shoe-cleaning product, or at least, the bottom sheet of a stack of sheets, could be provided with a bottom nonskid surface. This could eliminate the need for a separate base portion and thus provide a shoe-cleaning mechanism that was entirely disposable. On the other hand, the embodiment of FIG. 4 could be used in combination with a base portion 510, as shown in FIG. 5 illustrating embodiment 500. Base portion 510 could be formed along the same lines as base portion 410, except that it would not have anti-slip components since these would be on the surface of the shoe-cleaning product.

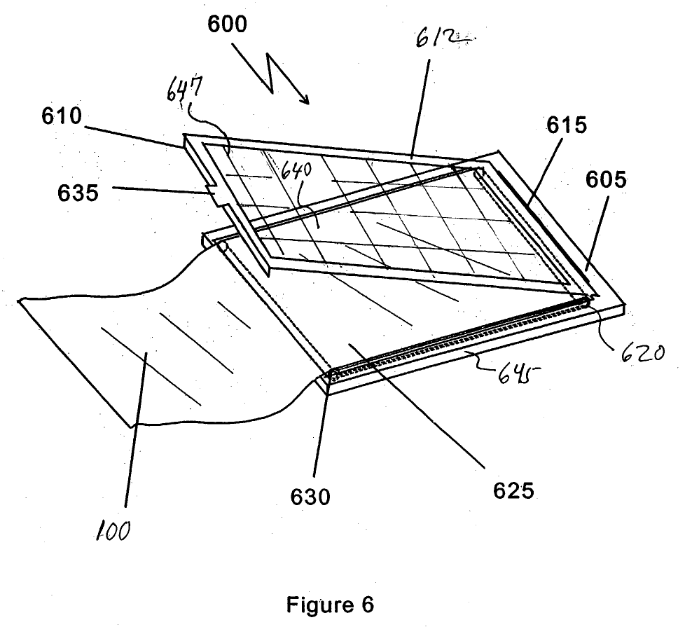

In still another embodiment of the present invention, the shoe-cleaning product 100 could be formed as a continuous extent or roll of material and used with a dispensing apparatus. FIG. 6 shows such an embodiment. In FIG. 6, an apparatus 600 comprises a housing 605 configured to receive the shoe-cleaning product 100 in a continuous or roll form. The housing may comprise a backing portion 645 having a bottom part configured for engaging a surface of a floor (for example, the bottom part may have a non-skid surface), and an upper part that forms a holder space 640. The housing may further comprise a movable frame part 612 that cooperates with the upper part of the backing portion via, for example, a hinge 615, to secure the shoe-cleaning material in the holder space. The movable frame part may be rotatable about the hinge 615 and adapted to engage the backing portion and an extent of the shoe-cleaning product, to secure the shoe-cleaning product within the housing.

When brought into engagement with the backing portion, the movable frame part may frame an area of the holder space that is at least large enough to accommodate a pair of adult-sized shoes. The movable frame part may have a handle 635. The apparatus may further include compressing or frictional members 647 for securing the shoe-cleaning material in place and helping to prevent slipping on the shoe-cleaning material when it is wet. The members 647 could be formed as transverse members as shown in FIG. 6, disposed across the frame part 612 so as to extend across the holder space when the frame part is brought into engagement with the backing portion, while leaving areas of the shoe-cleaning material exposed for contacting the soles of shoes. However, other configurations of members for further securing the shoe-cleaning material and providing an anti-slip function are possible. The apparatus may be sufficiently rugged and low to the ground that it may be easily and repeatedly stepped on or walked over.

The apparatus may further include a mechanism for dispensing the shoe-cleaning product. For example, the shoe-cleaning product could be in the form of a roll, and a roller 620 could be provided for retaining a roll of the shoe-cleaning product. An extent of the shoe-cleaning product exposed within the holder space of the apparatus could be used until it was soiled, and then a clean, unused extent 625 of the product could be advanced from the roll by pulling on one end of the roll. The dispensing mechanism could further include a cutting edge for separating the used extent from the unused extent. For example, a cutting edge 610 could be formed on the movable frame part 612 to cut through the shoe-cleaning product to separate the used extent from the unused extent. Alternatively, a straight, rigid edge of some kind could be provided at an end of the holder space, and the used extent could be separated from the unused extent by simply pulling up the product against the straight edge.

A dispensing apparatus as described above may be advantageous in that it reduces manufacturing costs: i.e., the shoe-cleaning product need not be formed into separate sheets, or stacked, or have tabs applied. When used with such a dispensing apparatus, the second, water-resistant layer of the product prevents moisture from being transferred from the first layer onto the apparatus, keeping it dry and thus avoiding wetting a newly-advanced extent. The water-resistant layer could also help to keep the material in a roll from sticking together due to the tackiness of the first layer. Additionally, in applications where the water-absorbing layer was impregnated with a dry water-soluble cleaner, the water-resistant layer could help to slow or prevent evaporation of the cleaning solution.

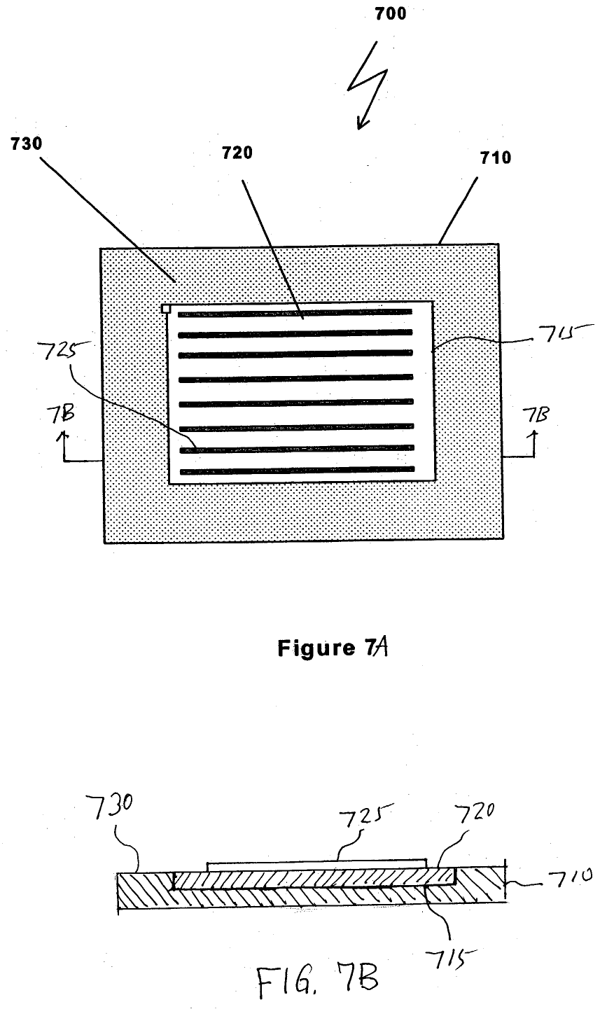

FIG. 7A illustrates yet another embodiment of the present invention. In FIG. 7A, an apparatus 700 comprises a shoe-cleaning product 720 associated with a floor covering 710. The shoe-cleaning product 720 could have any of the various forms discussed above: i.e., for example, it could have openings to engage anti-slip components, or could have anti-slip components on its top exposed surface. The shoe-cleaning product 720 could be formed as a plurality of separable members in a stack, each with tabs.

The floor covering 710 could form an outer perimeter 730 of the shoe-cleaning product. This outer perimeter may include floor covering materials such as, for example, carpet, sisal, fabric or rubber. The outer perimeter may serve to provide additional water absorbing or dissipating capacity, and may produce a more aesthetically pleasing result. At least a portion of the outer perimeter may be large enough to accommodate a pair of adult shoes thereon.

The shoe-cleaning product 720 may be removably received within an area 715 of the floor covering 710. For example, area 715 may be a recess as shown in cross-sectional view 7B. The anti-slip component 725 as shown in FIG. 7B could be, as noted above, formed on a top exposed surface of the shoe-cleaning product. Alternatively, the anti-slip component 725 could be formed in the area 715 of the floor covering, and engage an opening in the shoe-cleaning product. As shown in FIG. 7A, the area 715 may be in approximately the center of the floor covering 710.

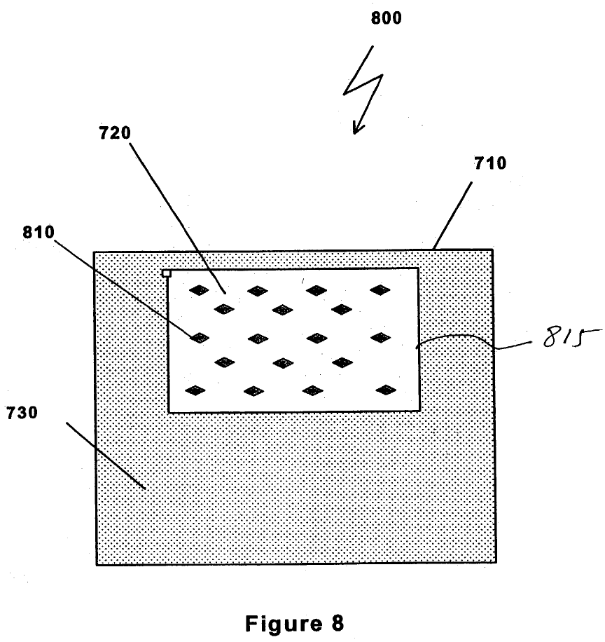

FIG. 8 shows an alternative embodiment. In FIG. 8, apparatus 800 comprises a shoe-cleaning product 720 associated with a floor covering 710, where anti-slip components 810 are nodular rather than elongated treads. In example of FIG. 8, the anti-slip components appear as small diamond shapes, but any shape, size or pattern for anti-slip components is considered to be within the scope of the present invention.

Further, the shoe-cleaning product may be removably received within an area 815 of the floor covering, where the area 815 is off-center with respect to the floor covering. This arrangement may leave a region of floor covering material 730 that is at least large enough to accommodate a pair of adult shoes.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A shoe-cleaning product, comprising:
a first layer comprising water-absorbing material and having a porous top tacky surface; and
a second layer comprising water-resistant material, adjacent to the first layer.

2. The shoe-cleaning product of claim 1, wherein the product includes at least one of a cleaning solution and an antibacterial agent.

3. The shoe-cleaning product of claim 1, wherein the product has electrostatic properties.

4. The shoe-cleaning product of claim 1, the first and second layers forming a composite unitary member.

5. The shoe-cleaning product of claim 4, wherein the product is configured as a plurality of the members separably arranged in a stack.

6. The shoe-cleaning product of claim 4, wherein the member comprises at least one opening therethrough configured to receive at least one anti-slip component of a base portion.

7. The shoe-cleaning product of claim 4, wherein the member comprises a tab for facilitating manipulation of the member.

8. The shoe-cleaning product of claim 6, further comprising the base portion, the at least one anti-slip component of the base portion engaging the member via the at least one opening.

9. The shoe-cleaning product of claim 4, the first layer including at least one anti-slip component on a top exposed surface thereof.

10. An apparatus comprising:
a housing configured to receive a shoe-cleaning product for, the housing comprising:
a backing portion having a bottom part configured for engaging a surface of a floor, and an upper part that forms a holder space; and
a movable frame part that cooperates with the upper part of the backing portion to secure a shoe-cleaning material in the holder space and frame an area of the holder space that is at least large enough to accommodate a pair of adult-sized shoes;
wherein the housing is configured to be arranged on a floor and to be stepped or walked on.

11. The apparatus of claim 10, further comprising a mechanism for dispensing the shoe-cleaning product.

12. The apparatus of claim 11, wherein the mechanism comprises at least one roller configured to retain an extent of the shoe-cleaning product in roll form.

13. The apparatus of claim 11, wherein the mechanism comprises a cutting edge for separating a first extent of the shoe-cleaning product from a second extent of the shoe-cleaning product retained within the housing.

14. The apparatus of claim 10, the movable frame part being rotatably coupled to the upper part of the backing portion and having a cutting edge thereon that may be brought into engagement with a shoe-cleaning product received within the holder space.

15. The apparatus of claim 10, further comprising a shoe-cleaning product received within the housing, the shoe-cleaning product including a first layer comprising water-absorbing material and having a top tacky exposed surface, and a second layer comprising water-resistant material, adjacent to the first layer.

16. The apparatus of claim 10, further comprising compressing or frictional members for securing a shoe-cleaning material within the holder space and preventing slipping on the shoe-cleaning material when it is wet.

17. The apparatus of claim 16, wherein the compressing or frictional members are formed as transverse members disposed across the frame part.

18. An apparatus comprising:
a floor covering; and
a shoe-cleaning product associated with the floor covering, the shoe-cleaning product including a first layer comprising porous water-absorbing material and having a top tacky exposed surface, and a second layer comprising water-resistant material, adjacent to the first layer.

19. The apparatus of claim 18, the floor covering forming an outer perimeter of the shoe-cleaning product and including at least one of a water dissipating and a water absorbing capability.

20. The apparatus of claim 18, the outer perimeter including at least one of carpet, sisal, fabric and rubber.

21. The apparatus of claim 18, the floor covering including an area configured to receive the shoe-cleaning product, the area having at least one anti-slip component cooperating with the shoe-cleaning product.

22. The apparatus of claim 21, the shoe-cleaning product having at least one opening therethrough configured to engage the at least one anti-slip component.

23. The apparatus of claim 18, wherein the product is configured as a plurality of members separably arranged in a stack.

24. The apparatus of claim 23, wherein each member comprises a tab for facilitating manipulation of the member.

25. The apparatus of claim 21, wherein the at least one anti-slip component is formed as a tread.

26. The apparatus of claim 21, wherein the at least one anti-slip component is formed as a nodular element.

27. The apparatus of claim 21, wherein the area is in approximately the center of the floor covering.

28. The apparatus of claim 21, wherein the area is off-center with respect to the floor covering.
